(19) United States
(12) Patent Application Publication
(10) Pub. No.: US 2010/0108034 A1
(43) Pub. Date: May 6, 2010

(54) Rotary Engine

(76) Inventor: Michel Arseneau, Beauharnois (CA)

Correspondence Address: DOBE LAW GROUP, LLC, 7207 HANOVER PARKWAY, SUITE C/D, GREENBELT, MD, 20770, US

(21) Appl. No.: 12/595,095

(22) PCT Filed: Apr. 9, 2008
(86) PCT No.: PCT/CA08/00658

§ 371 Date: Oct. 8, 2009

Related U.S. Application Data
(60) Provisional application No. 60/922,387, filed on Apr. 9, 2007.

(51) Int. Cl. F02B 75/26

(52) U.S. Cl. 123/45 A

(57) ABSTRACT

A rotary engine (1) is characterised by a driven output shaft (30) powered by internal combustion carried out in a cylinder (26) to drive a piston (50) and crankshafts (70, 80) carrying contra-rotating drive gears (10, 12) meshing with a fixed gear ring (88), rotation of the gears (10, 12) transmitting rotary motion to the piston (50) and the cylinder (26), the gear cage base (32), gears (10, 12) and to the output shaft (30). The contra-rotation of the gears (10, 12) on the respective crankshaft (70, 80) provides for a balanced power transmission.

### FIELD OF THE INVENTION

The present invention relates to internal combustion engines, and is more particularly concerned with such engines categorised as rotary engines.

### BACKGROUND OF THE INVENTION

Conventional internal combustion engines employ one or more cylinders in each of which reciprocates a piston driven by the explosive power generated by the combustion of a fuel triggered by the use of either a spark or compression. The power so produced is used to drive a shaft for use in traction, for example in motor vehicles, or for static use in other machinery or indeed to produce more power, for example by the deployment of a generator.

Various proposals have been made to vary this manner of operation, for example the Wankel Engine which uses one or more specially shaped rotors mounted on a drive shaft, fuel being combusted to provide the motive power to turn the rotor(s) to drive the shaft. Another example of a rotary engine was that used in some early military planes during the First World War, the characterizing feature being that the piston casing drove the propeller, rather than the crankshaft per se. Other rotary engines were tested in prototypic form in motor cycles and in early road vehicles. The principal surviving type of rotary engine is the Wankel Engine a version of which remains commercially available in Mazda® cars.

An advantage of rotary engines is the enhanced power-to-weight ratio compared to conventional internal combustion engines and improved balance. However, cost is an important factor and generally with commercially produced units, the degree of sophistication dictates a high production cost burden reflected in the selling price.

Accordingly, there is a need for an improved rotary engine displaying the advantages associated with engines of this general type but of low manufacturing cost and thus affordable product sales price.

### SUMMARY OF THE INVENTION

It is therefore a general object of the present invention to provide an improved rotary engine.

It is a further object of the present invention to propose such an engine in which there are unique constructional and operational elements at an economic manufacturing cost, resulting in reliability and efficiency available to consumers at a competitive and affordable price.

A still further object of the present invention is to provide a rotary engine of essentially modular construction, thus allowing of ease of replacing parts and interchangeability. Additionally, the modular construction affords versatility in power train design and function.

Moreover, an important object of the present invention is to provide a rotary engine with enhanced balance, low friction and low noise output.

According to the invention, a rotary engine is characterised by a cylinder casing, a cylinder axially rotatable within the casing, a cylinder head rotatable with and affixed to the top of the cylinder, at least one aperture provided in the cylinder head, a valving block fixed to the casing and registering with the cylinder head to provide associated ports, a piston reciprocable within the cylinder, at least two contra-rotatable crank shafts each having at least one throw, a connecting rod attached to each throw of the corresponding crankshaft and to the piston, a gear cage base attached to the cylinder, a pinion rigid with each crank shaft and rotatably mounted in said base for rotation in opposite senses, a fixed gear ring attached to the casing, each pinion meshing with the gear ring, and an outlet shaft connected to the gear cage base.

Conveniently, each pinion is in the form of a bevel gear and the fixed gear ring is correspondingly bevel-toothed.

A crank casing is provided and is attached at the end of the cylinder casing remote from the valving block, the cylinder casing housing the crankshafts and the gear cage and the gear ring being sandwiched and fixed between the cylinder casing and the crank casing, extending into the latter at the periphery thereof.

A gear cage base has bearing races provided for each of the crankshafts and a connection for the output shaft.

The gear cage base joins with a gear cage cradle forming the cylinder end remote from the valving block such that in use the cylinder and the piston rotate about their longitudinal axes as the gears are turned by the crankshafts with the gears meshing with the fixed gear ring.

The output shaft may be simply connected to the gear cage base or in the alternative an epicyclic gear assembly may be provided for the output shaft. A suitable bearing race is preferably provided in the gear cage base for the output shaft.

Each crankshaft may be provided with a counterweight for each throw.

The cylinder head is provided with suitable aperture(s) which in use sequentially register with corresponding inlets and outlets in the valving block, rotation of the cylinder in relation to the block bringing such registration in the appropriate sequence dictated by whether the internal combustion engine is four-stroke or two-stroke.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a side sectional view of a rotary engine in accordance with an embodiment of the present invention showing the piston at bottom dead centre within its cylinder;

FIG. 2 is a view corresponding to that of FIG. 1 but showing the piston at top dead centre;

FIG. 3 is a perspective external view of the rotary engine depicted in FIGS. 1 and 2;

FIG. 4 is a cross-sectional view of the rotating parts of the rotary engine with the piston at bottom dead centre;

FIG. 5 is a cross-sectional view of the two crankshafts at bottom dead centre;

FIG. 6 is a cross-sectional view similar to FIG. 5 of an alternative drive shaft;

FIG. 7 is a view of the crankshafts, connecting rods and drive gears at mid-stroke of the piston in its cylinder;

FIG. 8 is a cross-sectional view along the line B-B in FIG. 9;

FIG. 9 is a view of the piston and crankshafts with connecting rods at mid-stroke of the piston in its cylinder;

FIG. 10 is a perspective view of the piston and cranking assemblies at mid-stroke;

FIGS. 11-15 are detailed views of the valving arrangements;

FIG. 11 is a view on the line A-A of FIG. 12 showing the end of the cylinder head;

FIG. 12 is a view of the valve block assembly;

FIG. 13 is an exploded view of the valving arrangements and the cylinder;

FIG. 14 is a view of the intake and exhaust valving arrangements along the line C-C of FIG. 15;

FIG. 15 is a view of an assembled rotary engine in accordance with the present invention;

FIG. 16 is a perspective view of all the rotating parts of the engine assembled with a planetary gear box for the outlet shaft; and

FIG. 17 is a similar view to that of FIG. 16 but with a simple outlet shaft arrangement of FIG. 6.

### DETAILED DESCRIPTION OF THE PREFERRED EMBODIMENTS

With reference to the annexed drawings the preferred embodiments of the present invention will be herein described for indicative purpose and by no means as of limitation.

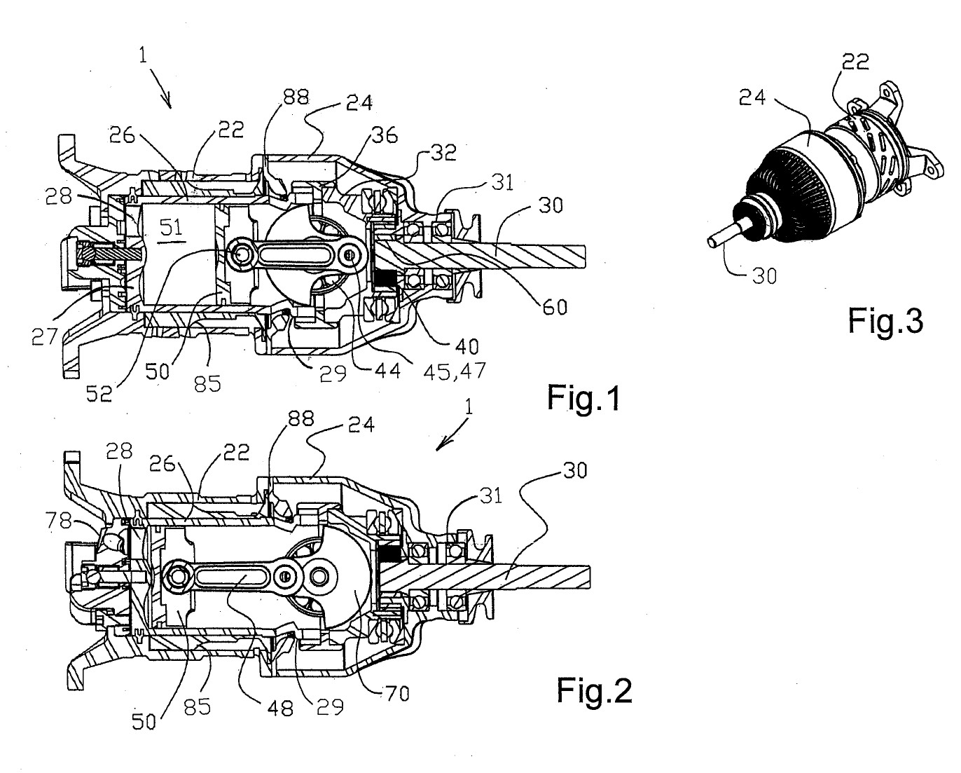

Reference is now made to FIGS. 1 and 2 in which a rotary engine in accordance with an embodiment of the present invention is shown generally at 1 and comprises a cylinder or engine casing 22 accommodating within its cavity a rotatable cylinder 26 provided with cooling fins 85 which are a snug fit to ensure smooth rotary movement of the cylinder 26 within the said cavity. The cylinder 26 is provided with a cylinder head 27 having a suitable aperture 28 as described hereinafter.

A crank casing 24 is attached to the cylinder casing 22, with a gear ring 88 therebetween, as shown and provides an outlet ball race 31 for an output shaft 30.

The cylinder 26 at its end remote from the head 27 forms a gear cage cradle 29 attaching to a gear cage cradle base 32 and a crankshaft outer support 36, the bearing 44 being provided between both the cradle 29 and the base 32, and the crankshafts 70, 80. In FIGS. 1 and 2 an epicyclic gearbox 40 is attached to the gear cage base 32 in the region of the bearing 44, the output shaft 30 having teeth 60 at its relatively inner end for meshing engagement with the other gears of the box, the shaft 30 extending from this gearbox 40. In other embodiments, for example as shown in FIG. 6, a simple connection, such as a mechanical joint, is made between the shaft 30 and the gear cage base 33 for the transmission of power.

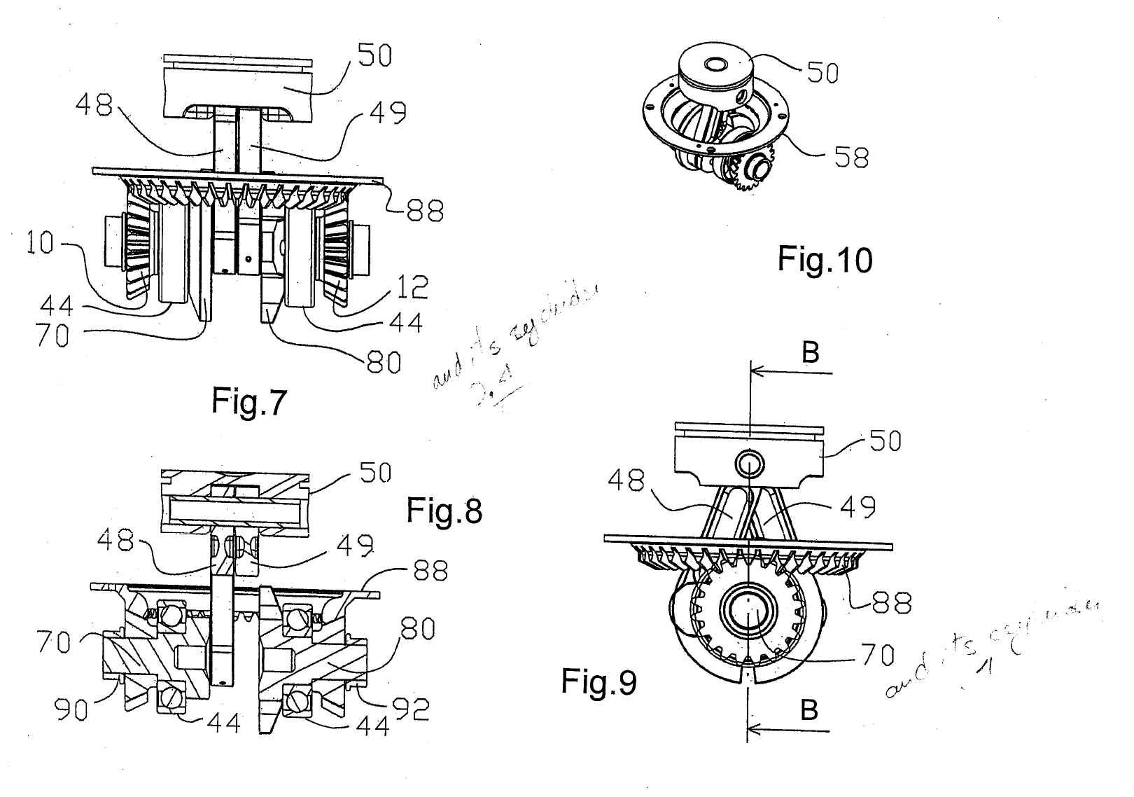

A piston 50 is reciprocable within the cylinder 26, which defines a combustion space 51 as referenced in FIG. 1. The piston 50 is carried through the agency of a piston pin 52 by two connecting rods 48, 49 which extend from respective throws or crank pins 45, 47 carried on two separate and contra-rotating crankshafts 70, 80. Each of the shafts 70, 80 carries a bevel gear pinion 10, 12 respectively, which in turn meshes with the bevel gear ring 88 fixed between the cylinder casing 22 and the crank casing 24. The shafts 70, 80 are carried in bearings 90, 92 in the crankshaft support 36 and are also mounted in bearings 44, as shown more particularly in FIGS. 7 and 8.

FIG. 9 illustrates in particular that the connecting rods 48, 49 act individually and translate contra-rotation to the respective crankshafts 70, 80. This figure also shows the engine with its piston at mid stroke position with the connecting rods 48, 49 allowing significant reduction of the side loading from the piston 50 and the wall of cylinder 26 (not shown in this view).

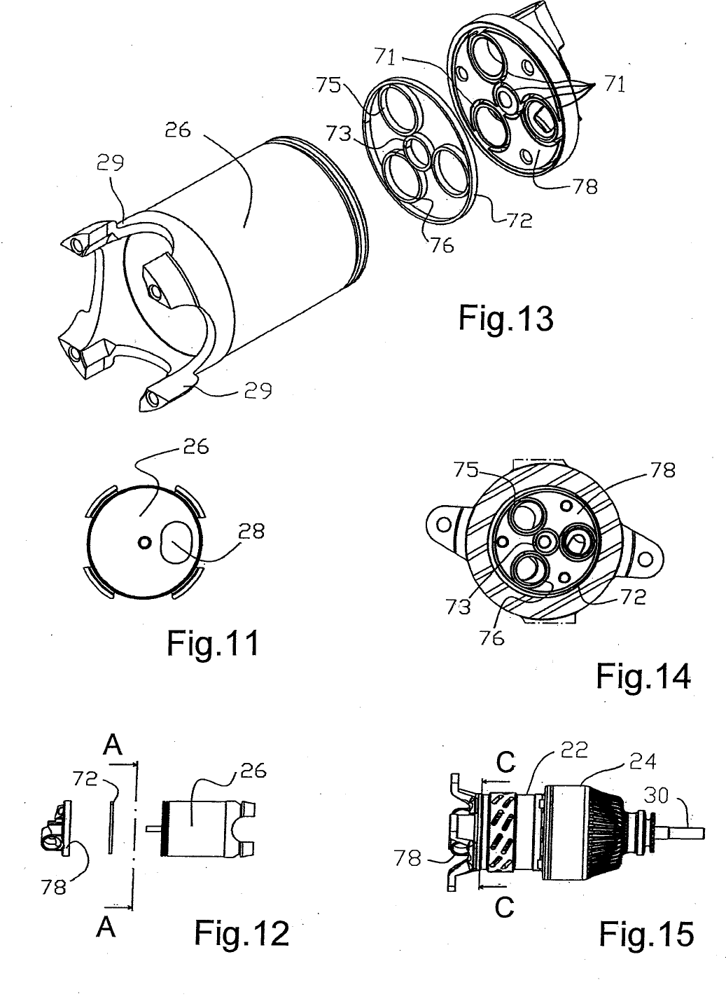

FIGS. 11 to 15 show three components which constitute the valving arrangements for the engine 1. FIG. 11 shows a cylinder head 27 in the form of a disc which rotates with the cylinder 26 during its rotation, the head having an aperture 28 intended to register sequentially with appropriate inlet and outlet ports in a fixed valving block 78 held in one end of the cylinder casing 22. The valving block 78 includes at least two (one inlet and one outlet—for a diesel-type engine), typically three ports (one inlet, one outlet and one ignition—for a spark ignition-type engine), as shown herein. Whilst the present embodiment relates to a four-stroke engine, a two-stroke engine is possible by varying the number of apertures 28.

In FIGS. 13 to 15, and more specifically in FIG. 13 an exploded view of the valving arrangement of the present invention is shown and in particular a comprehensive seal is provided with rings 72, 73, 75 and 76 which register within corresponding grooves 71 formed within the valving block 78 circumjacent respective inlet and outlet ports, as well as at the inner and outer peripheries thereof. Although not shown the grooves 71 are typically provided within their bases with wave or undulated spring blades to ensure appropriate pressure is applied to create an adequate and effective seal as between the valving block 78 and head 27. Further, although not required, there can be seen from the illustration in FIG. 13 that the seals are provided with cuts that permit efficient sealing within the grooves 71 of the block 78. It will be appreciated that during use it is the ring seals that will contact the machined surface of the head 27. From FIG. 14 it will be observed that the seal rings 72, 73, 75 and 76 are eccentric in relation to the cylinder head 27 thus ensuring that the aperture 28 in the head 27 will always be surrounded during rotation and that the seal rings will not always contact the same area in the cylinder head 27.

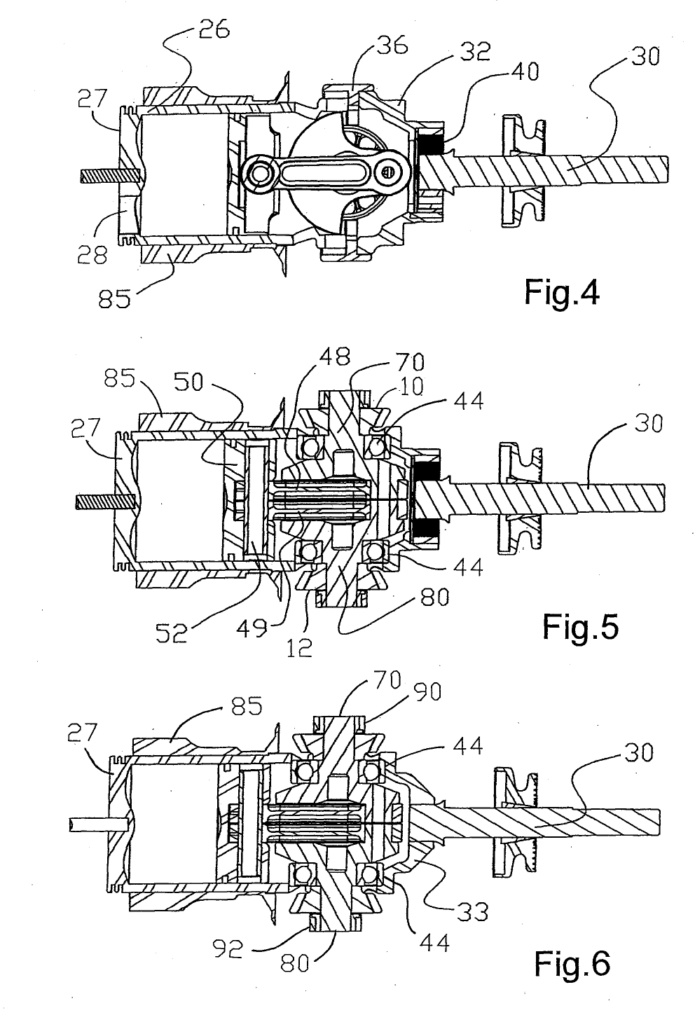

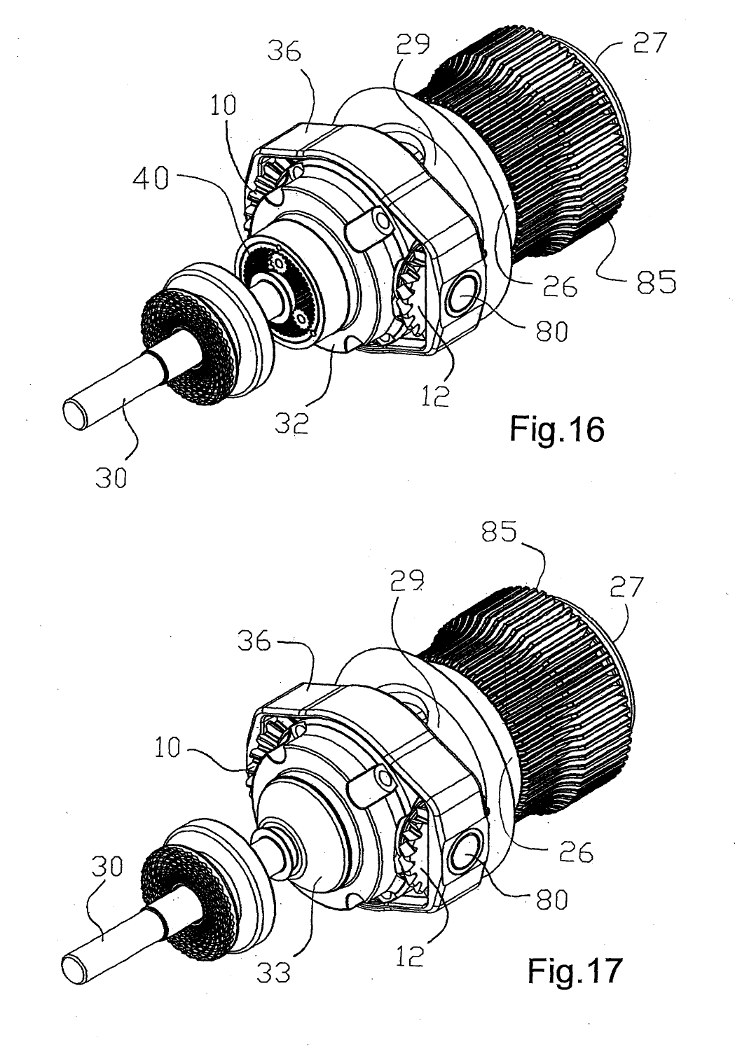

In operation, the rotary engine 1 of the present invention would be coupled to a load of some description requiring rotational power. A fuel supply would be coupled to the valving block 78 via an appropriate fuel distributor, e.g. a carburettor, and a spark igniter (not shown) is provided for giving the requisite initiation for ignition to occur thereby to drive the piston 50 longitudinally within the cylinder 26. In so doing the crankshafts 70 and 80 are caused to rotate synchronously in opposite directions by the thrust of the piston on the connecting rods 48 and 49. The rotation of the crankshafts 70 and 80 triggers rotation of the bevel gears 10, 12, which contra-rotate, and through the meshing engagement with the static bevel gear ring 88 the piston 50 and the cylinder 26 together with the other moving parts rotate about the cylinder axis (not shown) and in so doing the gear cage cradle 29 and the gear cage base 32 rotate the output shaft 30 to transmit drive to the working load (not shown). The contra-rotation of the connecting rods 48, 49 provides a balanced power transmission which minimises vibration and thus noise generation. All components illustrated in FIGS. 4, 5 and 16 do rotate about the cylinder axis during operation of the engine 1; and similarly for the embodiment of FIGS. 6 and 17. Accordingly, fuel economy is an advantage to be gained by the inventive configuration disclosed herein.

In an other embodiment (not shown), the seal rings 72, 73, 75 and 76 could be replaced by a single seal ring that would be in register with a corresponding groove surrounding the head aperture 28 and be in sealing contact with a machined surface of the valving block 28. In such an embodiment, there is less parts and only the valving block 28 gets replaced when worn out by the sealing ring, instead of the cylinder head 27.

It is to be understood that other configurations could be adopted whereby more than a single cylinder would be provided; however the balanced loading achieved with the single cylinder should be maintained. Since the engine is essentially modular, a series of these modules could be assembled in a suitable array to provide the power required in any given circumstance.

While a specific embodiment of the rotary engine of the present invention has been described, those skilled in the art will recognize many alterations that could be made within the spirit of the invention. The description provided herein is provided only for purposes of illustration, and not for purposes of limitation.

1. A rotary engine characterised by comprising a cylinder casing, a cylinder axially rotatable within the casing, a cylinder head rotatable with and affixed to the top of the cylinder, at least one aperture provided in the cylinder head, a valving block fixed to the casing and registering with the cylinder head to provide associated ports, a piston reciprocable within the cylinder, at least two contra-rotatable crankshafts each having at least one throw, a connecting rod attached to each throw of the corresponding crankshaft and to the piston, a gear cage base attached to the cylinder, a gear pinion rigid with each crankshaft and rotatably mounted in said base for rotation in opposite senses, a fixed gear ring attached to the casing, each gear pinion meshing with the gear ring, and an outlet shaft connected to the gear cage base.

2. The rotary engine according to claim 1, wherein each pinion is in the form of a bevel gear and the fixed gear ring is correspondingly bevelled.

3. The rotary engine according to claim 1 or 2, wherein a crank casing is provided and is attached to the casing remote from the valving block.

4. The rotary engine according to claim 1, wherein the gear cage base comprises bearing races provided for each of the crank shafts.

5. The rotary engine according to claim 4, wherein the gear cage base is provided with a connection for the output shaft.

6. The rotary engine according to claim 4 or 5, wherein the gear cage base joins with a gear cage cradle forming the end of the cylinder remote from the valving block such that in use the cylinder and the piston rotate about their longitudinal axes as the gears are turned by the crankshafts with the gears meshing with the fixed gear ring.

7. The rotary engine according to claim 4, wherein the output shaft is connected to the gear cage base by a simple mechanical joint.

8. The rotary engine according to claim 4, wherein the output shaft is connected to the gear cage base through the agency of an epicyclic gear assembly.

9. The rotary engine according to claim 1, wherein the valving block comprises at least two ports for sequential registration with the aperture in the cylinder head.

10. The rotary engine according to claim 9, wherein the cylinder head is provided with a seal ring adapted for reception in a corresponding groove formed therein circumjacent the aperture.

11. The rotary engine according to claim 9, wherein the valving block is provided with seal rings adapted for reception in corresponding grooves formed therein circumjacent the inlet and outlet ports thereof.

12. The rotary engine according to claim 11, wherein the seal rings are eccentric in relation to the cylinder head.

13. The rotary engine according to claim 11, wherein the grooves comprise spring blades.

14. The rotary engine according to claim 1, wherein the cylinder is provided externally thereof with cooling fins.

15. The rotary engine according to claim 1, wherein the engine is a spark ignition engine and a spark plug is provided for triggering combustion of a fuel within the cylinder.
